(19) United States
(12) Patent Application Publication
(10) Pub. No.: US 2013/0070179 A1
(43) Pub. Date: Mar. 21, 2013

(54) Liquid Crystal Display and Fabrication Method Thereof

(71) Applicant: Jun-Hyuk Kim, Gyeongsangbuk-Do (KR)

(72) Inventor: Jun-Hyuk Kim, Gyeongsangbuk-Do (KR)

(73) Assignee: LG Display Co., Ltd.

(21) Appl. No.: 13/587,035

(22) Filed: Aug. 16, 2012

(30) Foreign Application Priority Data
Sep. 15, 2011 (KR) 10-2011-0093099

(51) Int. Cl. G02F 1/1333

(52) U.S. Cl. 349/58; 445/24

(57) ABSTRACT

A liquid crystal display (LCD) device and a fabrication method are provided. Black ink is printed on an inner surface of a side wall of a main supporter on which a liquid crystal panel is mounted, thereby improving a light leakage due to brightness of the side wall of the main supporter. The liquid crystal display (LCD) device including: a liquid crystal panel outputting an image; a backlight installed on a rear surface of the liquid crystal panel and emitting light to a front surface of the liquid crystal panel; and a main supporter receiving the liquid crystal panel and the backlight and fixing them, wherein an ink layer made of certain ink is formed on an inner surface of a side wall of the main supporter to prevent a light leakage of the backlight through the side wall of the main supporter.

The present disclosure relates to subject matter contained in priority Korean Application No. 10-2011-0093099, filed on Sep. 15, 2011, which is herein expressly incorporated by reference in its entirety.

### FIELD OF THE INVENTION

The present invention relates to a liquid crystal display (LCD) and a fabrication method thereof, and more particularly, to an LCD device in which a light leakage through of a side wall of a main supporter is improved and a fabrication method thereof.

### DESCRIPTION OF THE RELATED ART

In general, a liquid crystal display (LCD) device is a display device in which data signals according to image information are individually provided to pixels arranged in a matrix form to adjust light transmittance of the pixels to thus display a desired image.

Thus, the LCD device includes a liquid crystal panel in which pixels are arranged in a matrix form and drivers for driving the pixels.

The liquid crystal panel includes a thin film transistor array substrate and a color filter substrate which are attached in a facing manner with a uniform cell gap maintained therebetween, and a liquid crystal layer formed in the cell gap between the array substrate and the color filter substrate.

Here, a common electrode and a pixel electrode are formed on the liquid crystal panel formed as the array substrate and the color filter substrate are attached, to apply an electric field to the liquid crystal layer.

Thus, when a voltage of the data signal applied to the pixel electrode is controlled in a state in which a voltage is applied to the common electrode, liquid crystal of the liquid crystal layer rotates by dielectric anisotropy according to an electric field between the common electrode and the pixel electrode, allowing light to be transmitted or blocked by pixel, to thus display characters or images.

In this case, the LCD device is a light receiving type device, rather than emitting light by itself, which displays an image by adjusting transmittance of light received from the outside, so it requires an additional device, i.e., a backlight, for irradiating light to the liquid crystal panel.

The backlight is divided into an edge type backlight in which lamps are disposed at one side or at both sides of the liquid crystal panel and light is reflected, diffused and collected (or focused) through light guide plate, a reflective plate, and optical sheets so as to be transmitted to the front surface of the liquid crystal panel, and a direct type backlight in which lamps are disposed on a rear surface of the liquid crystal panel to allow light to be directly transmitted (or irradiated) to the front surface of the liquid crystal panel.

FIG. 1 is a sectional view schematically showing a portion of a related art LCD device, in which a portion of the configuration of an LCD device having an edge type backlight is schematically shown.

As illustrated in FIG. 1, the related art LCD device includes a liquid crystal panel 10 outputting an image as liquid crystal is injected between the color filter substrate 6 and the array substrate 5, and a backlight installed on a rear surface of the liquid crystal panel 10 to emit light to the entire surface of the liquid crystal panel 10, and a main supporter 45 for receiving and fixing the liquid crystal panel 10 and the backlight.

At this time, upper and lower polarizers 1 and 11 are attached to an outer portion of each of the color filter substrate 6 and the array substrate 5, and the upper polarizer 1 polarizes light that goes through the liquid crystal panel and the lower polarizer 11 polarizes light that goes through the backlight.

In detail, in the backlight, an LED assembly (not shown) generating light is installed at one side of a light guide plate 42, and a reflective plate 41 are installed on a rear surface of the light guide plate 42.

Here, although not shown, the LED assembly includes an LED array, an LED printed circuit board (PCB) driving the LED array, and a heat dissipation pad dissipating heat generated from the LED array.

Light emitted from the LED array is made incident to a lateral side of the light guide plate 42 made of a transparent material, and the reflective plate 41 disposed on the rear surface of the light guide plate 42 reflects light transmitted from the rear surface of the light guide plate 42 toward the optical sheets 43 on an upper surface of the light guide plate 42, thus reducing a loss of light and improving uniformity.

At an upper portion of the backlight configured thusly, the liquid crystal panel 10 comprised of the color filter substrate 6 and the array substrate 5 is mounted through the main supporter 45, and the liquid crystal panel 10, the main supporter 45, and the backlight are coupled through adhesive tapes 46 and 47 to constitute the LCD device.

At this time, in order to make the design thinner, the LCD device fabricated to be used in a mobile phone in which a top case component is eliminated and the liquid crystal panel 10 is attached to the main supporter 45 is assembled to a set 50. The main supporter 45 serving as a frame of the backlight uses a white color resin in order to maximize light efficiency. Thus, an upper side wall of the main supporter 45 having a white color is seen to be brighter while the backlight is driven, and after the LCD device is assembled to the set 50, a light leakage is generated at a viewing angle.

### SUMMARY OF THE INVENTION

An aspect of the present invention provides a liquid crystal display (LCD) device capable of improving a light leakage generated at a viewing angle after the LCD device is assembled to a set, and a fabrication method thereof.

Another aspect of the present invention provides an LCD device capable of improving a light leakage without increasing a tack time, and a fabrication method thereof.

The foregoing and other objects, features, aspects and advantages of the present invention will become more apparent from the following detailed description of the present invention when taken in conjunction with the accompanying drawings.

According to an aspect of the present invention, there is provided a liquid crystal display (LCD) device including: a liquid crystal panel outputting an image; a backlight installed on a rear surface of the liquid crystal panel and emitting light to a front surface of the liquid crystal panel; and a main supporter receiving the liquid crystal panel and the backlight and fixing them, wherein an ink layer made of certain ink is formed on an inner surface of a side wall of the main supporter to prevent a light leakage of the backlight through the side wall of the main supporter.

The main supporter may be made of a white color resin.

The ink layer may be formed on at least one of four sides (left-right-top-bottom) of the side walls of the main supporter.

The ink layer may be formed on all of the four sides of the side walls of the main supporter.

The ink layer may be made of black ink.

The ink layer may be made of ink of a color including gray color, other than black color.

According to another aspect of the present invention, there is provided a method of fabricating a liquid crystal display (LCD) device, including: coating certain ink on a pad; aligning the pad at an upper portion of a main supporter used for an LCD device so as to be positioned; pressing the pad to the main supporter to form an ink layer made of the ink on an inner surface of a side wall of the main supporter; mounting a liquid crystal panel at an upper portion of the main supporter where the ink layer is formed, so as to be fixed thereto; and fixing a backlight to the main supporter.

Black ink may be coated on a sponge type pad.

The pad may be formed as a stamp pad with black ink imbued therein.

The pad may be pressed to the main supporter by utilizing a jig.

The ink layer may be formed on at least one of four sides (left-right-top-bottom) of the side walls of the main supporter.

The ink layer may be formed on the entire four surfaces of the side wall of the main supporter.

According to embodiments of the present invention, in the LCD device and a fabrication method, since black ink is printed on an inner surface of the side wall of the main supporter on which the liquid crystal panel is mounted, a light leakage due to brightness of the side wall of the main supporter can be improved.

In particular, the LCD device and its fabrication method according to embodiments of the present invention have a low unit cost (e.g. U.S. $0.135) and an excellent tack-time when compared to a double injection molding scheme. Also, since existing injection-molding equipment can be used as is, additional investments in equipment are not required and there are no special considerations that need to be taken into account when designing the required parts and components.

### BRIEF DESCRIPTION OF THE DRAWINGS

FIG. 1 is a sectional view schematically showing a portion of a related art liquid crystal display (LCD) device.

FIG. 2 is a sectional view schematically showing a portion of an LCD device according to a first embodiment of the present invention.

FIG. 3 is an exploded perspective view schematically showing a portion of an LCD device according to a second embodiment of the present invention.

FIG. 4 is a sectional view schematically showing a portion of an LCD device according to the second embodiment of the present invention.

FIGS. 5A to 5C are views showing an example of a method of printing black ink on an inner surface of a side wall of a main supporter in the LCD device according to the second embodiment of the present invention illustrated in FIG. 4.

### DETAILED DESCRIPTION OF THE INVENTION

A liquid crystal display (LCD) device and a fabrication method thereof according to an embodiment of the present invention will be described in detail with reference to the accompanying drawings.

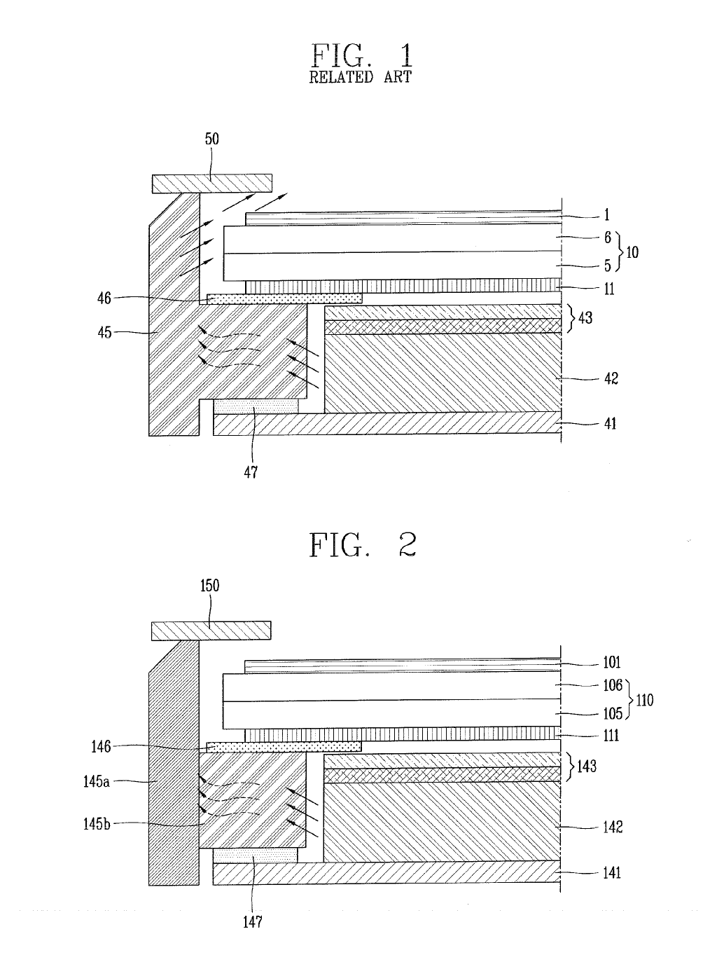

FIG. 2 is a sectional view schematically showing a portion of an LCD device according to a first embodiment of the present invention, in which a portion of the configuration of an LCD device having an edge type backlight is schematically shown. However, the present invention can be applicable to an LCD having a direct type backlight, without being limited thereto.

As illustrated in FIG. 2, the LCD device according to the first embodiment of the present invention includes a liquid crystal panel 110 outputting an image, and a backlight installed on a rear surface of the liquid crystal panel 110 to emit light to the entire surface of the liquid crystal panel 110, and main supporters 145a and 145b for receiving and fixing the liquid crystal panel 110 and the backlight.

The liquid crystal panel 110 includes a color filter substrate 106 and an array substrate 105 which are attached in a facing manner with a uniform cell gap maintained therebetween, and a liquid crystal layer (not shown) formed in the cell gap between the color filter substrate 106 and the array substrate 105.

Although not shown, a common electrode and a pixel electrode are formed on the liquid crystal panel formed as the color filter substrate and the array substrate are attached, to apply an electric field to the liquid crystal layer. When a voltage of the data signal applied to the pixel electrode is controlled in a state in which a voltage is applied to the common electrode, liquid crystal of the liquid crystal layer rotates by dielectric anisotropy according to an electric field between the common electrode and the pixel electrode, allowing light to be transmitted or blocked by pixel, to thus display characters or images.

In order to control a voltage of a data signal applied to the pixel electrode by pixel, a switching element such as a thin film transistor (TFT) is provided in each of the pixels.

Upper and lower polarizers 101 and 111 are attached to outer portions of the liquid crystal panel 110, and the upper polarizer 101 polarizes light that goes through the liquid crystal panel and the lower polarizer 111 polarizes light that goes through the backlight.

In detail, in the backlight, a light source such as an LED assembly (not shown) generating light is installed at one side of a light guide plate 142, and a reflective plate 141 are installed on a rear surface of the light guide plate 142. However, the present invention is not limited thereto and a light source employing a cold cathode fluorescent lamp (CCFL) may also be used.

Although not shown, the LED assembly includes an LED array, an LED printed circuit board (PCB) driving the LED array, and a heat dissipation pad dissipating heat generated from the LED array.

Light emitted from the LED array is made incident to a lateral side of the light guide plate 142 made of a transparent material, and the reflective plate 141 disposed on the rear surface of the light guide plate 142 reflects light transmitted from the rear surface of the light guide plate 142 toward the optical sheets 143 on an upper surface of the light guide plate 142, thus reducing a loss of light and improving uniformity.

At an upper portion of the backlight configured thusly, the liquid crystal panel 110 comprised of the color filter substrate 106 and the array substrate 105 is mounted through the main supporters 145a and 145b. The liquid crystal panel 110, the main supporters 145a and 145b, and the backlight are coupled through adhesive tapes 146 and 147 to constitute the LCD device. At this time, the adhesive tapes 146 and 147 attach (or couple) the liquid crystal panel 110 and the main supporters 145a and 145b. The adhesive tapes 146 and 147 may be configured as a black upper adhesive tape 146 preventing a light leakage to the edge of the optical sheets 143 and a lower adhesive tape 147 coupling the main supporters 145a and 145b and the reflective plate 141.

Here, in the main supporters 145a and 145b according to the first embodiment of the present invention, the side wall 145a involving a possibility of a light leakage is injection-molded with a black color resin, having a double injection mold structure.

Thus, after a set 150 is assembled, an existing problem of a light leakage generated at a viewing angle may be solved, but double injection molding equipment should be disadvantageously applied.

Namely, in order to injection-mold a mounting portion 145b of the main supporters 145a and 145b, on which the liquid crystal panel 110 is to be mounted, at the later surface of the light guide plate 142, with a white color resin and the side wall 145a of the main supporters 145a and 145b, which may cause a light leakage, with a black color resin, double injection molding equipment should be employed, and this makes the configuration complicated and lengthening an injection mold time to increase a tack time. Also, when the double injection molding is applied, strength is weak in comparison to a single resin, having a possibility in which cracks may be formed in the interface of the two different types of resins.

Thus, in order to avoid such a problem, black ink may be printed only on the inner surface of the side wall of the main supporters potentially causing a light leakage. This will be described in detail through a second embodiment of the present invention as follows.

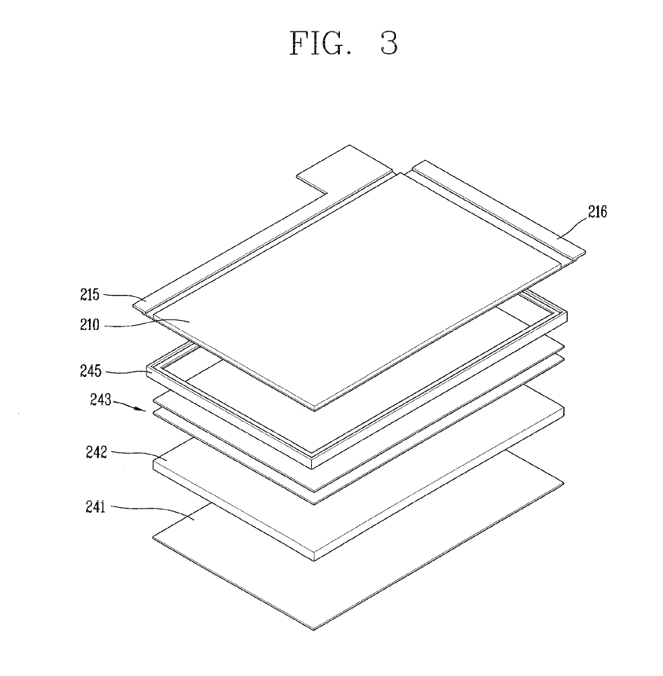

FIG. 3 is an exploded perspective view schematically showing a portion of an LCD device according to a second embodiment of the present invention.

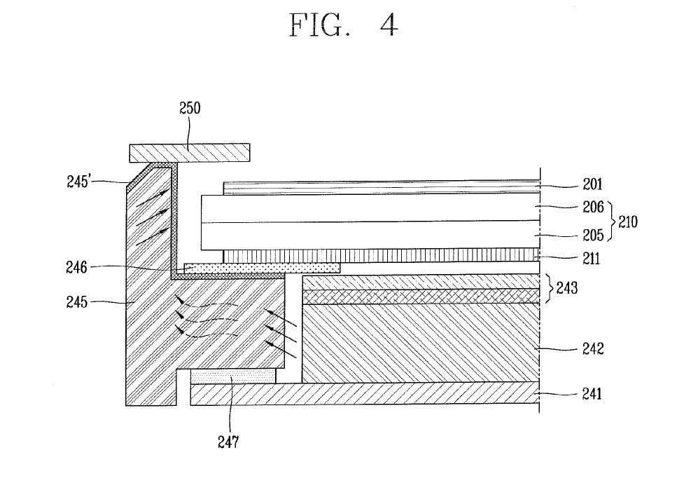

FIG. 4 is a sectional view schematically showing a portion of an LCD device according to the second embodiment of the present invention in which a portion of the configuration of an LCD device having an edge type backlight is schematically shown. However, the present invention can be applicable to an LCD having a direct type backlight, without being limited thereto.

As illustrated in FIGS. 3 and 4, the LCD device according to the first embodiment of the present invention includes a liquid crystal panel 210 outputting an image, and a backlight installed on a rear surface of the liquid crystal panel 210 to emit light to the entire surface of the liquid crystal panel 210, and a main supporter 245 for receiving and fixing the liquid crystal panel 210 and the backlight.

The liquid crystal panel 210 includes a color filter substrate 206 and an array substrate 205 which are attached in a facing manner with a uniform cell gap maintained therebetween, and a liquid crystal layer (not shown) formed in the cell gap between the color filter substrate 206 and the array substrate 205.

Although not shown, a common electrode and a pixel electrode are formed on the liquid crystal panel 210 formed as the color filter substrate 206 and the array substrate 205 are attached, to apply an electric field to the liquid crystal layer. When a voltage of the data signal applied to the pixel electrode is controlled in a state in which a voltage is applied to the common electrode, liquid crystal of the liquid crystal layer rotates by dielectric anisotropy according to an electric field between the common electrode and the pixel electrode, allowing light to be transmitted or blocked by pixel, to thus display characters or images. Certain driving circuit units 215 and 216 applying signals to the common electrode and the pixel electrode are connected to the array substrate 205 of the liquid crystal panel 210.

In order to control a voltage of a data signal applied to the pixel electrode by pixel, a switching element such as a thin film transistor (TFT) is provided in each of the pixels.

Upper and lower polarizers 201 and 211 are attached to outer portions of the liquid crystal panel 210, and the upper polarizer 201 polarizes light that goes through the liquid crystal panel 210 and the lower polarizer 211 polarizes light that goes through the backlight.

In detail, in the backlight, a light source such as an LED assembly (not shown) generating light is installed at one side of a light guide plate 242, and a reflective plate 241 are installed on a rear surface of the light guide plate 242. However, the present invention is not limited thereto and a light source employing a cold cathode fluorescent lamp (CCFL) may also be used.

Although not shown, the LED assembly includes an LED array, an LED printed circuit board (PCB) driving the LED array, and a heat dissipation pad dissipating heat generated from the LED array.

Light emitted from the LED array is made incident to a lateral side of the light guide plate 242 made of a transparent material, and the reflective plate 241 disposed on the rear surface of the light guide plate 242 reflects light transmitted from the rear surface of the light guide plate 242 toward the optical sheets 243 on an upper surface of the light guide plate 242, thus reducing a loss of light and improving uniformity.

At an upper portion of the backlight configured thusly, the liquid crystal panel 210 comprised of the color filter substrate 206 and the array substrate 205 is mounted through the main supporter 245, and the liquid crystal panel 210. The main supporter 245, and the backlight are coupled through adhesive tapes 246 and 247 to constitute the LCD device. At this time, the adhesive tapes 246 and 247 attach (or couple) the liquid crystal panel 210 and the main supporter 245. The adhesive tapes 246 and 247 may be configured as a black upper adhesive tape 246 preventing a light leakage to the edge of the optical sheets 243 and a lower adhesive tape 247 coupling the main supporter 245 and the reflective plate 241.

AT this time, the main supporter 245 according to the second embodiment of the present invention may include a black ink layer 245′ made of black ink and formed on the inner surface of the side wall that may cause a light leakage.

The black ink layer 245′ of the main supporter 245 may be formed through printing performed three to five times by using sponge or a stamp pad. However, the present invention is not limited thereto and an inkjet printing method may also be used.

Here, the printing may be performed on the entirety of the four left, right, upper and lower surfaces of the side wall of the main supporter 245, or may be performed on a particular surface among the four surfaces.

As for the color of printing, any colors such as gray, or the like, other than black, may also be used so long as it can suppress a brightness phenomenon.

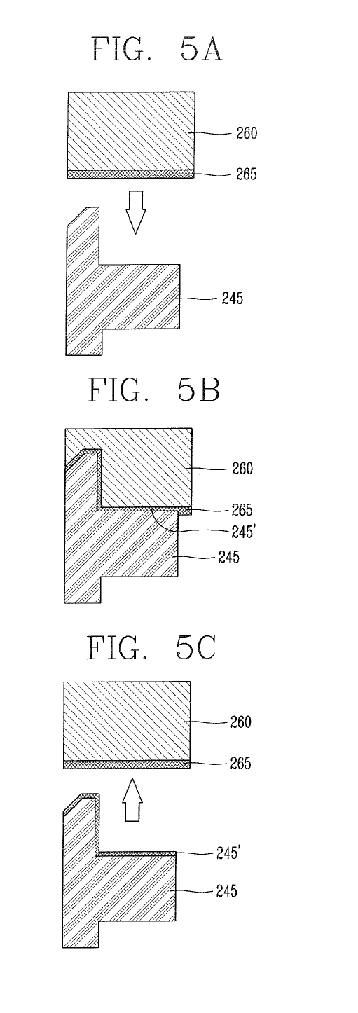

FIGS. 5A to 5C are views showing an example of a method of printing black ink on an inner surface of a side wall of a main supporter in the LCD device according to the second embodiment of the present invention illustrated in FIG. 4.

As shown in FIG. 5A, after coating black ink 265 on the sponge type pad 260, the sponge type pad 260 is aligned on an upper portion of the main supporter 245 so as to be positioned.

In this case, the pad 260 may be a stamp pad with the black ink 265 imbued therein.

Thereafter, as shown in FIG. 5B, the pad 260 is pressed to the main supporter 245 by using a jig (not shown) to form the black ink layer 245′ on the inner surface of the side wall of the main supporter 245.

After the printing operation is performed three to five times, as shown in FIG. 5C, the pad 260 is removed from the main supporter 245.

In this manner, in the second embodiment of the present invention, by printing black ink on the inner surface of the side wall of the main supporter on which the liquid crystal panel is mounted, a light leakage due to brightness of the side wall of the main supporter can be improved.

In particular, in the second embodiment of the present invention, for example, the unit cost (0.135$) can be lowered and an excellent tack time can be obtained in comparison to the double injection molding method (about 0.177$) according to the first embodiment of the present invention described above on the basis of a 3.2″ backlight. Also, since existing injection molding equipment is used as is, investments in any additional equipment are not required and there are no special considerations that need to be taken into account when designing the required parts or components.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A liquid crystal display (LCD) device comprising:
a liquid crystal panel outputting an image;
a backlight installed on a rear surface of the liquid crystal panel and emitting light to a front surface of the liquid crystal panel; and
a main supporter receiving the liquid crystal panel and the backlight and fixing them,
wherein an ink layer made of certain ink is formed on an inner surface of a side wall of the main supporter to prevent a light leakage of the backlight through the side wall of the main supporter.

2. The device of claim 1, wherein the main supporter is made of a white color resin.

3. The device of claim 1, wherein the ink layer is formed on at least one of four sides (left-right-top-bottom) of the side walls of the main supporter.

4. The device of claim 3, wherein the ink layer is formed on all of the four sides of the side walls of the main supporter.

5. The device of claim 1, wherein the ink layer is made of black ink.

6. The device of claim 1, wherein the ink layer is made of ink of a color including gray color, other than black color.

7. A method of fabricating a liquid crystal display (LCD) device, the method comprising:
coating certain ink on a pad;
aligning the pad at an upper portion of a main supporter used for an LCD device so as to be positioned;
pressing the pad to the main supporter to form an ink layer made of the ink on an inner surface of a side wall of the main supporter;
mounting a liquid crystal panel at an upper portion of the main supporter where the ink layer is formed, so as to be fixed thereto; and
fixing a backlight to the main supporter.

8. The method of claim 7, wherein black ink is coated on a sponge type pad.

9. The method of claim 7, wherein the pad is formed as a stamp pad with black ink imbued therein.

10. The method of claim 7, wherein the pad is pressed to the main supporter by utilizing a jig.

11. The method of claim 7, wherein the ink layer may be formed on at least one of four sides of the side walls of the main supporter.

12. The method of claim 11, wherein the ink layer is formed on all of the four sides of the side walls of the main supporter.
